(19) United States
(12) Patent Application Publication
(10) Pub. No.: US 2026/0111255 A1
(43) Pub. Date: Apr. 23, 2026

(54) NETWORK INTERFACE CARD CONFIGURATION METHOD AND APPARATUS, ELECTRONIC DEVICE, AND STORAGE MEDIUM

(71) Applicant: Suzhou MetaBrain Intelligent Technology Co., Ltd., Suzhou, Jiangsu (CN)

(72) Inventors: Wenxiao WANG, Suzhou, Jiangsu (CN); Pei CHEN, Suzhou, Jiangsu (CN); Dekui WANG, Suzhou, Jiangsu (CN)

(21) Appl. No.: 19/469,116

(22) PCT Filed: Jan. 7, 2025
(86) PCT No.: PCT/CN2025/071068

§ 371 Date: Sep. 25, 2025

(30) Foreign Application Priority Data
Jan. 30, 2024 (CN) 202410129720.1

(51) Int. Cl. G06F 9/455

(52) U.S. Cl. CPC G06F 9/45558; G06F 2009/45595

(57) ABSTRACT

The present application relates to a network interface card configuration method and apparatus, an electronic device, and a storage medium. The method includes: associating a target pod group with a target network interface card identifier during generation of the target pod group; obtaining a first required acceleration card resource corresponding to the target pod group in response to the fact that the target network interface card corresponding to the target network interface card identifier is the target virtual network interface card; and according to the first required acceleration card resource, configuring the target virtual network interface card for the target pod group, or mapping the target virtual network interface card to the target physical network interface card corresponding to the target virtual network interface card, and configuring the target physical network interface card corresponding to the target virtual network interface card for the target pod group.

### CROSS-REFERENCE TO RELATED APPLICATION

This application claims priority to Chinese Patent Application No. 2024101297201, filed on Jan. 30, 2024 in China National Intellectual Property Administration and entitled “Network Interface Card Configuration Method and Apparatus, Electronic Device, and Storage Medium”, which is hereby incorporated by reference in its entirety.

### FIELD

The present application relates to a network interface card configuration method and apparatus, an electronic device, and a storage medium.

### BACKGROUND

Kubernetes is one of the most popular pod orchestration and management platforms at present, while single root input/output virtualization (SR-IOV) technology is a critical component for providing high-performance network functions in virtualized environments. Over the past few years, the development of the SR-IOV technology in Kubernetes has achieved a remarkable progress.

Generally, a virtualization configuration solution for an SR-IOV network interface card in Kubernetes is completed based on three components, i.e., multus-cni, sriov-cni, and sriov-device-plugin. The sriov-device-plugin may identify and register a virtual network interface card virtualized from an SR-IOV physical network interface card into a Kubernetes cluster, while multus-cni and sriov-cni virtualize and configure a network interface card into a pod network stack during pod creation. Then the pod may communicate with other pods utilizing the virtual network interface cards through these virtual network interface cards.

However, virtualization of the network interface card is merely a virtualized product of the SR-IOV network interface card and only inherits some characteristics of the network interface card, but does not have all functions of the network interface card. In some specific scenes, the virtual network interface card might not meet task requirements. Therefore, task execution may be affected, and task failure may even be caused.

### SUMMARY

According to an embodiment of the present application, in a first aspect, provided is a network interface card configuration method, including:
associating a target pod group with a target network interface card identifier during generation of the target pod group, the target pod group being a pod group for executing deep learning tasks in a target server node;
determining whether a target network interface card corresponding to the target network interface card identifier is a target virtual network interface card or a target physical network interface card, the target virtual network interface card being obtained by virtualizing the target physical network interface card;
in response to the fact that the target network interface card corresponding to the target network interface card identifier is the target virtual network interface card, obtaining a first required acceleration card resource corresponding to the target pod group, the first required acceleration card resource being an acceleration card resource that is expected to be used for communication between the target pod group on the current server node and a pod group on another server node when the target pod group executes the deep learning task; and
according to the first required acceleration card resource, configuring the target virtual network interface card for the target pod group, or mapping the target virtual network interface card to the target physical network interface card corresponding to the target virtual network interface card, and configuring the target physical network interface card corresponding to the target virtual network interface card for the target pod group.

According to an embodiment of the present application, in a second aspect, provided is a network interface card configuration apparatus, including:
an allocation module, configured to associate a target pod group with a target network interface card identifier during generation of the target pod group, the target pod group being a pod group for executing deep learning tasks in a target server node;
a first determination module, configured to determine whether a target network interface card corresponding to the target network interface card identifier is a target virtual network interface card or a target physical network interface card, the target virtual network interface card being obtained by virtualizing the target physical network interface card;
a first obtaining module, configured to obtain a first required acceleration card resource corresponding to the target pod group in response to the fact that the target network interface card corresponding to the target network interface card identifier is the target virtual network interface card, the first required acceleration card resource being an acceleration card resource that is expected to be used for communication between the target pod group on the current server node and a pod group on another server node when the target pod group executes the deep learning tasks; and
a first configuration module, configured to configure the target virtual network interface card for the target pod group, or map the target virtual network interface card to the target physical network interface card corresponding to the target virtual network interface card, and configure the target physical network interface card corresponding to the target virtual network interface card for the target pod group.

According to an embodiment of the present application, in a third aspect, provided is an electronic device, including a memory and a processor, the memory and the processor being in communication connection with each other, the memory having computer instructions stored therein, the processor executing the computer instructions to execute the network interface card configuration method in the first aspect or any corresponding implementation.

According to an embodiment of the present application, in a fourth aspect, provided is a non-transitory computer-readable storage medium, the non-transitory computer-readable storage medium having computer instructions stored therein, the computer instructions being configured for causing a computer to execute the network interface card configuration method in the first aspect or any corresponding implementation.

Details of one or more embodiments of the present application are provided in the accompanying drawings and descriptions below. Other features and advantages of the present application become clear with reference to the specification, the accompanying drawings, and the claims.

### BRIEF DESCRIPTION OF THE DRAWINGS

In order to more clearly illustrate the technical solutions in specific embodiments of the present application or in the prior art, drawings used in the specific embodiments or the description of the prior art are simply described below. Apparently, the drawings in the following description are some embodiments of the present application. For those ordinary skilled in the art, other drawings might be obtained without creative effort according to these drawings.

FIG. 1 is a schematic flowchart of a network interface card configuration method according to an embodiment of the present application;

FIG. 2 is a schematic flowchart of another network interface card configuration method according to an embodiment of the present application;

FIG. 3 is a schematic flowchart of further another network interface card configuration method according to an embodiment of the present application;

FIG. 4 is a schematic flowchart of yet another network interface card configuration method according to an embodiment of the present application;

FIG. 5 is a schematic diagram of an architecture of a network interface card configuration method according to an embodiment of the present application;

FIG. 6 is a flowchart of pod group creation in a network interface card configuration method according to an embodiment of the present application;

FIG. 7 is a flowchart of pod group deletion in a network interface card configuration method according to an embodiment of the present application;

FIG. 8 is a block diagram of a network interface card configuration apparatus according to an embodiment of the present application;

FIG. 9 is a block diagram of a network interface card configuration apparatus according to an embodiment of the present application;

FIG. 10 is a block diagram of a network interface card configuration apparatus according to an embodiment of the present application;

FIG. 11 is a block diagram of a network interface card configuration apparatus according to an embodiment of the present application;

FIG. 12 is a schematic diagram of a hardware structure of an electronic device according to an embodiment of the present application; and

FIG. 13 is a schematic structural diagram of a non-transitory computer-readable storage medium according to an embodiment of the present application.

### DETAILED DESCRIPTION

To make the objective, technical solutions and advantages of embodiments of the present application clearer, the technical solutions in the embodiments of the present application are described clearly and completely in conjunction with accompanying drawings in the embodiments of the present application. Apparently, the described embodiments are some embodiments of the present application, not all embodiments. All other embodiments obtained by a person of skill in the art based on the embodiments of the present application without creative efforts shall fall within the protection scope of the present application.

Kubernetes is one of the most popular pod orchestration and management platforms at present, while a single root input/output virtualization (SR-IOV) technology is a critical component for providing high-performance network functions in virtualized environments. Over the past few years, the development of the SR-IOV technology in Kubernetes has achieved a remarkable progress. The SR-IOV technology enables finer control and allocation of network resources by dividing functions of a physical network interface card into multiple virtual network interface cards. The virtualization manner at a hardware level allows a pod to directly access underlying hardware devices, bypassing intermediate layers in traditional network virtualization, thereby significantly enhancing network performance and throughput. The application of SR-IOV technology in Kubernetes brings numerous benefits. Firstly, the SR-IOV technology might provide lower network latency and wider bandwidth, thereby increasing a running speed of applications. The SR-IOV technology is particularly suitable for workloads with high network performance requirements. Secondly, the SR-IOV technology might provide enhanced isolation and security, ensuring network traffic between different pods remains isolated to prevent malicious attacks and data leakage. The advancement of the SR-IOV technology in Kubernetes has brought higher network performance and improved security to pod applications. With support from hardware vendors and continuous advancements in related technologies, more innovations and applications of SR-IOV might be expected in the future development of Kubernetes.

Generally, a virtualization configuration solution for an SR-IOV network interface card in Kubernetes is completed based on three components, i.e., multus-cni, sriov-cni, and sriov-device-plugin. The sriov-device-plugin may identify and register a virtual network interface card virtualized from an SR-IOV physical network interface card into a Kubernetes cluster, while multus-cni and sriov-cni configure the virtual network interface card into a pod network stack during pod creation. Then the pod may communicate with other pods utilizing the virtual network interface cards through these virtual network interface cards. However, the virtual network interface card is merely a virtualized product of the SR-IOV network interface card and only inherits some characteristics of the virtual network interface card, but does not have all functions of the network interface card. In specific scenes, for example, when the Kubernetes cluster performs TensorFlow deep learning distributed training, different TensorFlow worker nodes need to configure a communication mode of a graphics processing unit (GPU) using an NVIDIA collective communications library (NCCL) communication framework. If the virtual network interface card is employed for communication between the workers, a problem that the optimization of the NCCL framework fails to take effect may be caused. In the scene, a physical function (PF) of the SR-IOV network interface card provides communication between the workers.

Therefore, an embodiment of the present application provides a network interface card configuration method. During creation of a target pod group, a target network interface card identifier is allocated to the target pod group. Then, whether a target network interface card corresponding to the target network interface card identifier is a target virtual network interface card or a target physical network interface card is determined; and when the target network interface card corresponding to the target network interface card identifier is the target virtual network interface card, the target virtual network interface card or the target physical network interface card corresponding to the target virtual network interface card is configured for the target pod group, whereby it may be ensured that the target pod group might execute tasks successfully in any scene, and the situation that the task requirements might not be met in specific scenes might be avoided. Task execution may be affected, and task failure may even be caused.

An actual application example of the present application in a distributed deep learning training scene is provided below. Unlike an infinity band (InfiniBand) network interface card, a remote direct memory access over converged Ethernet (RoCE) network interface card allows a remote direct memory (RDMA) function to be implemented over standard Ethernet infrastructure. The RoCE network interface card is regarded as a “cost-effective alternative” to the InfiniBand network interface card. Therefore, most deep learning training implements communications between GPUs across server nodes by utilizing the RDMA function of the RoCE network interface card. Furthermore, many RoCE network interface cards achieve an SR-IOV function, which allows a single physical peripheral component interconnect express (PCIe) device (such as a network adapter) to be virtualized into a plurality of independent virtual function (VF) network interface cards. These VF network interface cards may be allocated to different objects for use. Since the VF network interface card is directly connected with a physical hardware resource, the VF network interface card might provide performance similar to the PF network interface card, but may have performance loss compare to the PF network interface card. Therefore, in some scenes with relatively high performance requirements, the application of the PF network interface card may have greater benefits than the application of the VF network interface card.

The distributed deep learning training involves training of deep learning tasks across multiple server nodes of a cluster. The GPUs across different server nodes need to communicate via the RDMA protocol of the RoCE network interface card. Particularly for large model training, all GPUs on the server node are generally occupied for training, leaving no remaining GPUs available for other training tasks. Therefore, if the VF network interface card of the RoCE network interface card in the original technical solution is used for inter-GPU communication, an achieved effect may undoubtedly be inferior to using the PF network interface card for communication. The network interface card configuration method provided by the present application might rapidly identify the specific scenes (such as the scene where all GPUs of the server node are utilized) through specific algorithms. For example, a resource use amount of pods for training deep learning tasks may be retrieved from the Kubernetes platform for adaptive determination. More in some embodiments, by comparing available acceleration card resources on the server node carrying the pod with an expected required acceleration card resource for the deep learning tasks of the pods, if the deep learning tasks have low performance requirement, the VF network interface card may be allocated to the pod conducting the deep learning tasks; and particularly, if it is identified that the pod conducting the deep learning tasks require higher communication efficiency, the PF network interface card may be allocated automatically, and corresponding network segment Internet Protocol (IP) and routing information may be configured for these PF network interface cards.

In the process, according to the present solution, the VF network interface card is reported to Kubernetes as a resource. From the perspective of the Kubernetes, the VF network interface card resource is allocated to the pod (that is, the VF network interface card is loaded by the pod). However, in special scenes, according to the present solution, the VF network interface card may be mapped to the PF network interface card, the PF network interface card may be actually loaded into the pod to deceive Kubernetes (because the network interface card identifier remains to be an identifier of the virtual network interface card), making the Kubernetes believe that the VF network interface card is loaded into the pod. In a general scene, the VF network interface card is continued to be configured for the pod. Furthermore, according to the present solution, network segment information that originally belongs to the VF network interface card is configured for the PF network interface card, whereby the PF network interface card may perform communications through existing network routing devices.

Therefore, by employing the solution of the present embodiment, the corresponding VF network interface card might be loaded for the pod group with the virtual network interface card identifier according to different communication requirements of deep learning tasks of the server nodes, or the corresponding VF network interface card is mapped to the PF network interface card, and the PF network interface card is loaded into the pod group, thereby achieving different network interface card configurations under different performance requirements, and further enhancing the communication efficiency between the pod groups of a plurality of server nodes in a training process of the deep learning tasks.

According to an embodiment of the present application, provided is a network interface card configuration method embodiment. It should be noted that steps illustrated in the flowchart of the accompanying drawings might be executed in a computer system, such as a set of computer-executable instructions. Moreover, although a logic sequence is shown in the flowchart, the shown or described steps may be executed in a different sequence in some cases.

It should be noted that an execution body of the network interface card configuration method provided by the embodiments of the present application may be a network interface card configuration apparatus. The network interface card configuration apparatus may be implemented as some or all of an electronic device in a form of software, hardware, or a combination of the software and hardware, where the electronic device may be a server or a terminal. The server in the embodiments of the present application may be a server, or a server cluster including a plurality of servers. The terminal in the embodiments of the present application may be a smartphone, a personal computer, a tablet computer, a wearable device, an intelligent robot, or other intelligent hardware devices. In the following method embodiments, the electronic device being the execution body is taken as an example for description.

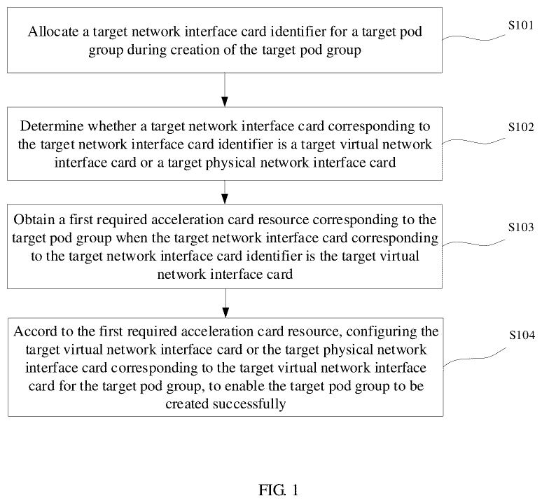

The present embodiment provides a network interface card configuration method. FIG. 1 is a flowchart of a network interface card configuration method according to an embodiment of the present application. As shown in FIG. 1, the process includes the following steps:
Step S101: allocating a target network interface card identifier to a target pod group during creation of the target pod group.

In some embodiments, before the target network interface card identifier is allocated to the target pod group, the electronic device may parse a profile of a physical network interface card in a Kubernetes cluster, and query information about an SR-IOV PF network interface card present on each server node according to the profile. Then, whether the server node corresponding to the target pod group performs virtualization on the physical network interface card is detected. If the physical network interface card is already virtualized, a single virtual network interface card identifier corresponding to each virtual network interface card is obtained, the virtual network interface card identifiers are spliced to generate a combined virtual network interface card identifier, and all combined virtual network interface card identifiers are reported. If the physical network interface card is not virtualized, a single physical network interface card identifier corresponding to each physical network interface card is obtained, the physical network interface card identifiers are spliced to generate a combined physical network interface card identifier, and all combined physical network interface card identifiers are reported.

Therefore, the target network interface card identifier is allocated to the target pod group during the creation of the target pod group. The target network interface card may be the combined physical network interface card identifier, or the combined virtual network interface card identifier.

Step S102: determining whether a target network interface card corresponding to the target network interface card identifier is a target virtual network interface card or a target physical network interface card.

The target virtual network interface card is obtained by virtualizing the target physical network interface card.

In some embodiments, the electronic device may identify the target network interface card identifier, and determines whether the target network interface card corresponding to the target network interface card identifier is the target virtual network interface card or the target physical network interface card according to an identification result.

For example, it is assumed that the single physical network interface card identifier is an uppercase letter such as A, B, C, or D, while the single virtual network interface card identifier is a lowercase letter such as a, b, c or d, whereby the electronic device may identify the target network interface card identifier, and determine whether the target network interface card corresponding to the target network interface card identifier is the target virtual network interface card or the target physical network interface card according to the identification result.

Step S103: obtaining a first required acceleration card resource corresponding to the target pod group when the target network interface card corresponding to the target network interface card identifier is the target virtual network interface card.

In some embodiments, when the target network interface card corresponding to the target network interface card identifier is the target virtual network interface card, the electronic device may read pod group information corresponding to the target pod group, and obtain the first required acceleration card resource corresponding to the target pod group.

Step S104: according to the first required acceleration card resource, configuring the target virtual network interface card or the target physical network interface card corresponding to the target virtual network interface card for the target pod group, to enable the target pod group to be created successfully.

In some embodiments, the electronic device may compare the first required acceleration card resource with a preset acceleration card resource. When the first required acceleration card resource is equal to or greater than the preset acceleration card resource, the target physical network interface card corresponding to the target virtual network interface card is configured for the target pod group; and when the first required acceleration card resource is less than the preset acceleration card resource, the target virtual network interface card is configured for the target pod group.

The present step may be described in detail below.

According to the network interface card configuration method provided by the embodiment of the present application, the target network interface card identifier is allocated to the target pod group during creation of the target pod group. Then, whether the target network interface card corresponding to the target network interface card identifier is the target virtual network interface card or the target physical network interface card is determined, whereby a type of the target network interface card corresponding to the target network interface card identifier and allocated to the target pod group may be clearly determined. When the target network interface card corresponding to the target network interface card identifier is the target virtual network interface card, the first required acceleration card resource corresponding to the target pod group is obtained; and according to the first required acceleration card resource, the target virtual network interface card or the target physical network interface card corresponding to the target virtual network interface card is configured for the target pod group, whereby the accuracy of the target virtual network interface card or the target physical network interface card corresponding to the target virtual network interface card configured for the target pod group might be ensured. It is further ensured that the target pod group might execute the task successfully in any scene, and might avoid failure in meeting task requirements in specific scenes. Task execution may be affected, and task failure may even be caused.

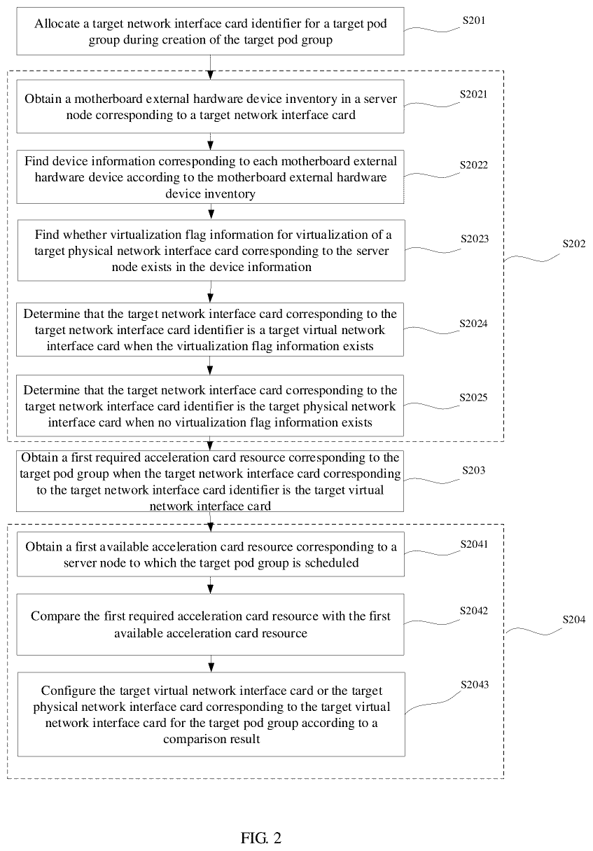

The present embodiment provides a network interface card configuration method. FIG. 2 is a flowchart of a network interface card configuration method according to an embodiment of the present application. As shown in FIG. 2, the process includes the following steps:
Step S201: allocating a target network interface card identifier to a target pod group during creation of the target pod group.

For the present step, refer to the description of step S101 in FIG. 1. Details are not described herein again.

Step S202: determining whether a target network interface card corresponding to the target network interface card identifier is a target virtual network interface card or a target physical network interface card.

The target virtual network interface card is obtained by virtualizing the target physical network interface card.

In an optional implementation of the present application, the foregoing step S202 may include the following steps:
Step S2021: obtaining a motherboard external hardware device inventory in a server node corresponding to the target network interface card.

In some embodiments, the electronic device may receive the motherboard external hardware device inventory in the server node corresponding to the target network interface card inputted by a user, or may receive the motherboard external hardware device inventory in the server node corresponding to the target network interface card transmitted by another device. The electronic device may further search a storage space for the motherboard external hardware device inventory in the server node corresponding to the target network interface card. A manner in which the electronic device obtains the motherboard external hardware device inventory in the server node corresponding to the target network interface card is not specified in the embodiments of the present application.

Step S2022: finding device information corresponding to each motherboard external hardware device according to the motherboard external hardware device inventory.

In some embodiments, the electronic device may find the device information corresponding to each motherboard external hardware device according to the motherboard external hardware device inventory after obtaining the motherboard external hardware device inventory.

Step S2023: finding whether virtualization flag information for virtualization of the target physical network interface card corresponding to the server node exists in the device information.

In some embodiments, the electronic device may identify the device information, and find whether the virtualization flag information for virtualization of the target physical network interface card corresponding to the server node in the device information according to an identification result.

Step S2024: determining that the target network interface card corresponding to the target network interface card identifier is the target virtual network interface card when the virtualization flag information exists.

In some embodiments, when the virtualization flag information exists, it is determined that the target physical network interface card is already virtualized, and consequently, it is determined that the target network interface card corresponding to the target network interface card identifier is the target virtual network interface card.

Step S2025: determining that the target network interface card corresponding to the target network interface card identifier is the target physical network interface card when no virtualization flag information exists.

In some embodiments, when no virtualization flag information exists, it is determined that the target physical network interface card is not virtualized, and consequently, it is determined that the target network interface card corresponding to the target network interface card identifier is the target physical network interface card.

Step S203: obtaining a first required acceleration card resource corresponding to the target pod group when the target network interface card corresponding to the target network interface card identifier is the target virtual network interface card.

For the foregoing step, refer to the description of step S103 in FIG. 1. Details are not described herein again.

Step S204: according to the first required acceleration card resource, configuring the target virtual network interface card or the target physical network interface card corresponding to the target virtual network interface card for the target pod group, to enable the target pod group to be created successfully.

In some embodiments, the foregoing step S204 may include the following steps:

Step S2041: obtaining a first available acceleration card resource corresponding to a server node to which the target pod group is scheduled.

In some embodiments, the electronic device may identify the server node to which the target pod group is scheduled, and determine the first available acceleration card resource corresponding to the server node to which the target pod group is scheduled.

Step S2042: comparing the first required acceleration card resource with the first available acceleration card resource.

In some embodiments, the electronic device may compare the first required acceleration card resource with the first available acceleration card resource.

Step S2043: according to a comparison result, configuring the target virtual network interface card or the target physical network interface card corresponding to the target virtual network interface card for the target pod group.

In some embodiments, the foregoing step S2043 may include the following steps:

Step a1: when the first required acceleration card resource is equal to the first available acceleration card resource, obtaining the target physical network interface card corresponding to the target virtual network interface card.

In some embodiments, when the first required acceleration card resource is equal to the first available acceleration card resource, the electronic device determines that the target pod group requires a relatively high amount of first required acceleration card resource, and the target virtual network interface card might not meet a service requirement of the target pod group. As a result, the target physical network interface card corresponding to the target virtual network interface card is obtained.

Step a2: configuring the target physical network interface card corresponding to the target virtual network interface card for the target pod group.

In some embodiments, the step a2 may include the following steps:

Step a21: obtaining a target physical network interface card identifier corresponding to the target physical network interface card.

In some embodiments, the electronic device may determine the target physical network interface card corresponding to the target virtual network interface card according to a correspondence between the target virtual network interface card and the target physical network interface card, and determine the target physical network interface card identifier corresponding to the target physical network interface card.

Step a22: writing the target physical network interface card identifier into an acceleration profile corresponding to the target pod group.

In some embodiments, the electronic device may write the target physical network interface card identifier into the acceleration profile corresponding to the target pod group.

Step a23: mounting the acceleration profile to the target pod group, and configuring the target physical network interface card to the target pod group.

In some embodiments, the electronic device may mount the acceleration profile to the target pod group.

The “configuring the target physical network interface card to the target pod group”in step a23 may include the following steps:

Step a231: generating a first unique Internet Protocol address corresponding to the target physical network interface card according to first network segment information corresponding to the target physical network interface card.

In some embodiments, the electronic device may receive the first network segment information corresponding to the target physical network interface card inputted by the user, or may receive the first network segment information corresponding to the target physical network interface card transmitted by another device, or may obtain the first network segment information corresponding to the target physical network interface card from the storage space. A manner in which the electronic device obtains the first network segment information corresponding to the target physical network interface card is not specified in the embodiment of the present application.

Subsequently, the electronic device generates the first unique Internet Protocol address corresponding to the target physical network interface card according to the first network segment information corresponding to the target physical network interface card.

The first network segment information is configured for representing a network segment interval of the first unique Internet Protocol address corresponding to the target physical network interface card.

The first unique Internet Protocol address is the first unique IP address corresponding to the target physical network interface card.

Step a232: moving the target physical network interface card to a pod network namespace corresponding to the target pod group from an initial network namespace.

In some embodiments, the electronic device may move the target physical network interface card to the pod network namespace corresponding to the target pod group from the initial network namespace.

Step a233: configuring the first unique Internet Protocol address for the target physical network interface card, and activating the target physical network interface card.

In some embodiments, the electronic device may configure the first unique Internet Protocol address for the target physical network interface card, and activate the target physical network interface card.

Step a3: when the first required acceleration card resource is less than the first available acceleration card resource, writing the target network interface card identifier into the acceleration profile.

In some embodiments, when the first required acceleration card resource is less than the first available acceleration card resource, the electronic device determines that the target virtual network interface card might meet the service requirement of the target pod group, and consequently writes the target network interface card identifier into the acceleration profile corresponding to the target pod group.

Step a4: mounting the acceleration profile to the target pod group, and configuring the target virtual network interface card to the target pod group.

In some embodiments, the electronic device may mount the acceleration profile to the target pod group.

In some embodiments, the “configuring the target virtual network interface card to the target pod group”in the foregoing step a4 may include the following steps:

Step a41: querying first data link information corresponding to the target virtual network interface card according to the target network interface card identifier information.

In some embodiments, the electronic device may query the first data link information corresponding to the target virtual network interface card according to the target network interface card identifier information.

Step a42: generating a second unique Internet Protocol address corresponding to the target virtual network interface card according to second network segment information corresponding to the target virtual network interface card.

In some embodiments, the electronic device may receive the second network segment information corresponding to the target virtual network interface card inputted by the user, or may receive the second network segment information corresponding to the target virtual network interface card transmitted by another device, or may obtain the second network segment information corresponding to the target virtual network interface card from the storage space. A manner in which the electronic device obtains the second network segment information corresponding to the target virtual network card is not specified in the embodiment of the present application.

After obtaining the second network segment information corresponding to the target virtual network interface card, the electronic device may randomly generate the second unique Internet Protocol address corresponding to the target virtual network interface card according to the second network segment information corresponding to the target virtual network interface card.

Step a43: generating a target physical address corresponding to the target virtual network interface card according to the second unique Internet Protocol address, and backing up a first original physical address corresponding to the target virtual network interface card.

In some embodiments, the electronic device may generate the target physical address corresponding to the target virtual network interface card according to the second unique Internet Protocol address, and back up the first original physical address corresponding to the target virtual network interface card.

It should be noted that the target physical address corresponding to the target virtual network interface card is also unique.

Step a44: configuring the target physical address for the target virtual network interface card according to the first data link information.

In some embodiments, the electronic device may configure the target physical address for the target virtual network interface card according to the first data link information.

For example, the electronic device may invoke an operation instruction “ip link set$vf link_name vf mac$mac_address”, to configure the target physical address for the target virtual network interface card.

Step a45: moving the target virtual network interface card to the pod network namespace corresponding to the target pod group from the initial network namespace. In some embodiments, the electronic device may move the target virtual network interface card to the pod network namespace corresponding to the target pod group from the initial network namespace.

Step a46: configuring the second unique Internet Protocol address for the target virtual network interface card according to the first data link information, and activating the target virtual network interface card.

In some embodiments, the electronic device may configure the second unique Internet Protocol address for the target virtual network interface card according to the first data link information, and activate the target virtual network interface card.

For example, the electronic device may invoke an operation instruction “ip link set$link_name down”, to configure the second unique Internet Protocol address for the target virtual network interface card.

According to the network interface card configuration method provided by the embodiments of the present application, the motherboard external hardware device inventory in the server node corresponding to the target network interface card is obtained, and the device information corresponding to each motherboard external hardware device is found according to the motherboard external hardware device inventory, thereby ensuring the accuracy of the found device information corresponding to each motherboard external hardware device. Whether the virtualization flag information for virtualization of the target physical network interface card corresponding to the server node exists in the device information is found; and when the virtualization flag information exists, it is determined that the target network interface card corresponding to the target network interface card identifier is the target virtual network interface card, thereby ensuring the accuracy of a determination result that the target network interface card corresponding to the target network interface card identifier is the target virtual network interface card. When no virtualization flag information exists, it is determined that the target network interface card corresponding to the target network interface card identifier is the target physical network interface card, thereby ensuring the accuracy of the determination result that the target network interface card corresponding to the target network interface card identifier is the target physical network interface card.

Furthermore, the first available acceleration card resource corresponding to the server node to which the target pod group is scheduled is obtained; and the first required acceleration card resource is compared with the first available acceleration card resource. When the first required acceleration card resource is equal to the first available acceleration card resource, the target physical network interface card corresponding to the target virtual network interface card is obtained; the target physical network interface card identifier corresponding to the target physical network interface card is obtained; the target physical network interface card identifier is written into the acceleration profile corresponding to the target pod group; and the acceleration profile is mounted to the target pod group. The first unique Internet Protocol address corresponding to the target physical network interface card is generated according to the first network segment information corresponding to the target physical network interface card, thereby ensuring the accuracy of the generated first unique Internet Protocol address corresponding to the target physical network interface card. The target physical network interface card is moved to the pod network namespace corresponding to the target pod group from the initial network namespace, whereby the target pod group may perform communication based on the target physical network interface card in the corresponding pod network namespace. The first unique Internet Protocol address is configured for the target physical network interface card, and the target physical network interface card is activated. The target pod group may accomplish tasks in any scene based on the target physical network interface card. Configuring the target virtual network interface card for the target pod group is avoided, and failure in meeting the task requirements in some specific scenes is avoided. Task execution may be affected, and task failure may even be caused.

When the first required acceleration card resource is less than the first available acceleration card resource, the target network interface card identifier is written into the acceleration profile corresponding to the target pod group, whereby the target pod group may find the target virtual network interface card based on the acceleration profile. The first data link information corresponding to the target virtual network interface card is queried according to the target network interface card identifier information, thereby ensuring accuracy of the queried first data link information. The second unique Internet Protocol address corresponding to the target virtual network interface card is generated according to the second network segment information corresponding to the target virtual network interface card, thereby ensuring accuracy of the generated second unique Internet Protocol address. The target physical address corresponding to the target virtual network interface card is generated according to the second unique Internet Protocol address, and the first original physical address corresponding to the target virtual network interface card is backed up, thereby ensuring accuracy of the generated target physical address corresponding to the target virtual network interface card, and enabling the target virtual network interface card to be restored based on the first original physical address. The target physical address is configured for the target virtual network interface card according to the first data link information, thereby ensuring accuracy of the target physical address configured for the target virtual network interface card. The target virtual network interface card is moved to the pod network namespace corresponding to the target pod group from the initial network namespace, whereby the target pod group may perform communication based on the target virtual network interface card in the corresponding pod network namespace. The second unique Internet Protocol address is configured for the target virtual network interface card according to the first data link information, and the target virtual network interface card is activated, whereby the target pod group may accomplish the tasks in any scene based on the target virtual network interface card. On the premise of ensuring that the target pod group may accomplish the tasks based on the target virtual network interface card, the resource of the target physical network interface card is saved.

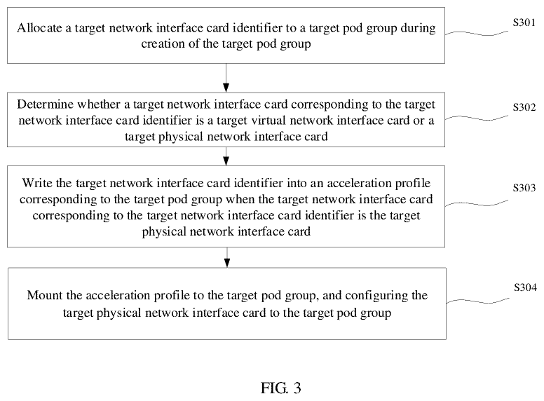

The present embodiment provides a network interface card configuration method. FIG. 3 is a flowchart of a network interface card configuration method according to an embodiment of the present application. As shown in FIG. 3, the process includes the following steps:

Step S301: allocating a target network interface card identifier to a target pod group during creation of the target pod group.

For the foregoing step, refer to the description of step S201 in FIG. 2. Details are not described herein again.

Step S302: determining whether a target network interface card corresponding to the target network interface card identifier is a target virtual network interface card or a target physical network interface card.

The target virtual network interface card is obtained by virtualizing the target physical network interface card.

For the foregoing step, refer to the description of step S202 in FIG. 2. Details are not described herein again.

Step S303: writing the target network interface card identifier into an acceleration profile corresponding to the target pod group when the target network interface card corresponding to the target network interface card identifier is the target physical network interface card.

In some embodiments, when the target network interface card corresponding to the target network interface card identifier is the target physical network interface card, the electronic device writes the target network interface card identifier into the acceleration profile corresponding to the target pod group.

Step S304: mounting the acceleration profile to the target pod group, and configuring the target physical network interface card to the target pod group.

In some embodiments, the electronic device generates the first unique Internet Protocol address corresponding to the target physical network interface card according to the first network segment information corresponding to the target physical network interface card; move the target physical network interface card to the pod network namespace corresponding to the target pod group from the initial network namespace; and configure the first unique Internet Protocol address for the target physical network interface card, and activate the target physical network interface card.

According to the network interface card configuration method provided by the embodiment of the present application, when the target network interface card corresponding to the target network interface card identifier is the target physical network interface card, the target network interface card identifier is written into the acceleration profile corresponding to the target pod group; and the acceleration profile is mounted to the target pod group, and the target physical network interface card is configured to the target pod group. The target pod group may find the target physical network interface card based on the acceleration profile, whereby the target pod group may accomplish the tasks in any scene based on the target physical network interface card.

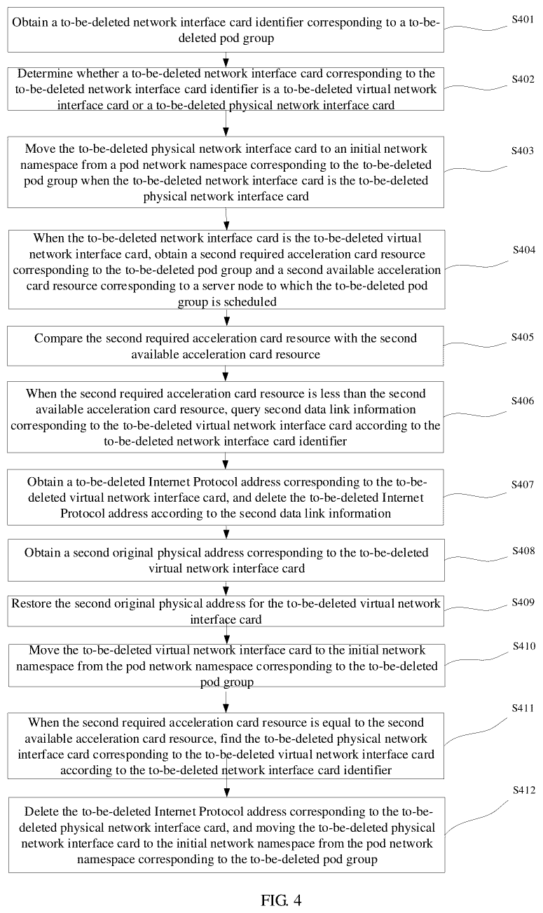

The present embodiment provides a network interface card configuration method. FIG. 4 is a flowchart of a network interface card configuration method according to an embodiment of the present application. As shown in FIG. 4, the process includes the following steps:

Step S401: obtaining a to-be-deleted network interface card identifier corresponding to a to-be-deleted pod group.

In some embodiments, the electronic device may receive the to-be-deleted pod group specified by the user, identify the to-be-deleted pod group, and determine a to-be-deleted network interface card identifier corresponding to the to-be-deleted pod group.

Step S402: determining whether a to-be-deleted network interface card corresponding to the to-be-deleted network interface card identifier is a to-be-deleted virtual network interface card or a to-be-deleted physical network interface card.

In some embodiments, the electronic device may obtain a motherboard external hardware device inventory in a server node corresponding to the to-be-deleted network interface card; find device information corresponding to each motherboard external hardware device according to the motherboard external hardware device inventory; find whether virtualization flag information for virtualization of the to-be-deleted physical network interface card corresponding to the server node exists in the device information; determine that the to-be-deleted network interface card corresponding to the to-be-deleted network interface card identifier is the to-be-deleted virtual network interface card when the virtualization flag information exists; and determine that the to-be-deleted network interface card corresponding to the to-be-deleted network interface card identifier is the to-be-deleted physical network interface card when no virtualization flag information exists.

Step S403: moving the to-be-deleted physical network interface card to an initial network namespace from a pod network namespace corresponding to the to-be-deleted pod group when the to-be-deleted network interface card is the to-be-deleted physical network interface card.

In some embodiments, when the to-be-deleted network interface card is the to-be-deleted physical network interface card, the to-be-deleted physical network interface card is moved to the initial network namespace from the pod network namespace corresponding to the to-be-deleted pod group.

Step S404: when the to-be-deleted network interface card is the to-be-deleted virtual network interface card, obtaining a second required acceleration card resource corresponding to the to-be-deleted pod group and a second available acceleration card resource corresponding to a server node to which the to-be-deleted pod group is scheduled.

In some embodiments, when the to-be-deleted network interface card is the to-be-deleted virtual network interface card, the second required acceleration card resource corresponding to the to-be-deleted pod group and the second available acceleration card resource corresponding to the server node to which the to-be-deleted pod group is scheduled are obtained.

Step S405: comparing the second required acceleration card resource with the second available acceleration card resource.

In some embodiments, the electronic device compares the second required acceleration card resource with the second available acceleration card resource.

Step S406: when the second required acceleration card resource is less than the second available acceleration card resource, querying second data link information corresponding to the to-be-deleted virtual network interface card according to the to-be-deleted network interface card identifier.

In some embodiments, when the second required acceleration card resource is less than the second available acceleration card resource, the electronic device determines that the to-be-deleted virtual network interface card is configured to the to-be-deleted pod group. Therefore, the electronic device queries the second data link information corresponding to the to-be-deleted virtual network interface card according to the to-be-deleted network interface card identifier.

Step S407: obtaining a to-be-deleted Internet Protocol address corresponding to the to-be-deleted virtual network interface card, and deleting the to-be-deleted Internet Protocol address according to the second data link information.

In some embodiments, the electronic device may identify the to-be-deleted virtual network interface card, determine the to-be-deleted Internet Protocol address corresponding to the to-be-deleted virtual network interface card, and then delete the to-be-deleted Internet Protocol address according to the second data link information. For example, the electronic device may delete the to-be-deleted Internet Protocol address by utilizing an operation instruction “ip link set$link_name down”.

Step S408: obtaining a second original physical address corresponding to the to-be-deleted virtual network interface card.

In some embodiments, the electronic device may search a storage space for the second original physical address corresponding to the to-be-deleted virtual network interface card according to the to-be-deleted network interface card identifier corresponding to the to-be-deleted virtual network interface card.

Step S409: restoring the second original physical address for the to-be-deleted virtual network interface card.

In some embodiments, the electronic device may restore the second original physical address corresponding to the to-be-deleted virtual network interface card.

Step S410: moving the to-be-deleted virtual network interface card to the initial network namespace from the pod network namespace corresponding to the to-be-deleted pod group.

In some embodiments, the electronic device may move the to-be-deleted virtual network interface card to the initial network namespace from the pod network namespace corresponding to the to-be-deleted pod group.

Step S411: when the second required acceleration card resource is equal to the second available acceleration card resource, finding the to-be-deleted physical network interface card corresponding to the to-be-deleted virtual network interface card according to the to-be-deleted network interface card identifier.

In some embodiments, when the second required acceleration card resource is equal to the second available acceleration card resource, the electronic device determines that the to-be-deleted physical network interface card is configured to the to-be-deleted pod group, whereby the electronic device finds the to-be-deleted physical network interface card corresponding to the to-be-deleted virtual network interface card according to the to-be-deleted network interface card identifier.

Step S412: deleting the to-be-deleted Internet Protocol address corresponding to the to-be-deleted physical network interface card, and moving the to-be-deleted physical network interface card to the initial network namespace from the pod network namespace corresponding to the to-be-deleted pod group.

In some embodiments, the electronic device deletes the to-be-deleted Internet Protocol address corresponding to the to-be-deleted physical network interface card, and moves the to-be-deleted physical network interface card to the initial network namespace from the pod network namespace corresponding to the to-be-deleted pod group.

According to the network interface card configuration method provided by the embodiment of the present application, the to-be-deleted network interface card identifier corresponding to the to-be-deleted pod group is obtained; and whether the to-be-deleted network interface card corresponding to the to-be-deleted network interface card identifier is the to-be-deleted virtual network interface card or the to-be-deleted physical network interface card is determined, whereby the to-be-deleted network interface card may be deleted according to a type of the to-be-deleted network interface card. When the to-be-deleted network interface card is the to-be-deleted physical network interface card, the to-be-deleted physical network interface card is moved to the initial network namespace from the pod network namespace corresponding to the to-be-deleted pod group, whereby the to-be-deleted physical network interface card corresponding to the to-be-deleted pod group is deleted, the to-be-deleted physical network interface card is released, and the to-be-deleted pod group might be deleted.

When the to-be-deleted network interface card is the to-be-deleted virtual network interface card, the second required acceleration card resource corresponding to the to-be-deleted pod group and the second available acceleration card resource corresponding to the server node schedule by the to-be-deleted pod group are obtained; and the second required acceleration card resource is compared with the second available acceleration card resource, whereby the type of the to-be-deleted network interface card configured for the to-be-deleted pod group might be determined according to a comparison result. Subsequently, the to-be-deleted network interface card is deleted according to the type of the to-be-deleted network interface card. When the second required acceleration card resource is less than the second available acceleration card resource, it is determined that the to-be-deleted network interface card configured for the to-be-deleted pod group is the to-be-deleted virtual network interface card. The second data link information corresponding to the to-be-deleted virtual network interface card is queried according to the to-be-deleted network interface card identifier, thereby ensuring accuracy of the found second data link information corresponding to the to-be-deleted virtual network interface card. The to-be-deleted Internet Protocol address corresponding to the to-be-deleted virtual network interface card is obtained, and the to-be-deleted Internet Protocol address is deleted according to the second data link information, thereby ensuring accuracy of deleting the to-be-deleted Internet Protocol address. The second original physical address corresponding to the to-be-deleted virtual network interface card is obtained; the second original physical address is restored for the to-be-deleted virtual network interface card; and the to-be-deleted virtual network interface card is moved to the initial network namespace from the pod network namespace corresponding to the to-be-deleted pod group. Therefore, the to-be-deleted virtual network interface card is deleted from the pod network namespace corresponding to the to-be-deleted pod group, and the to-be-deleted virtual network interface card is released, whereby the to-be-deleted pod group is inoperable, and the to-be-deleted pod group might be deleted.

When the second required acceleration resource is equal to the second available acceleration card resource, the to-be-deleted physical network interface card corresponding to the to-be-deleted virtual network interface card is found according to the to-be-deleted network interface card identifier, thereby ensuring accuracy of the found to-be-deleted physical network interface card. The to-be-deleted Internet Protocol address corresponding to the to-be-deleted physical network interface card is deleted, and the to-be-deleted physical network interface card is moved to the initial network namespace from the pod network namespace corresponding to the to-be-deleted pod group. Therefore, the to-be-deleted physical network interface card corresponding to the to-be-deleted pod group is deleted, and the to-be-deleted physical network interface card is released, whereby the to-be-deleted pod group might be deleted.

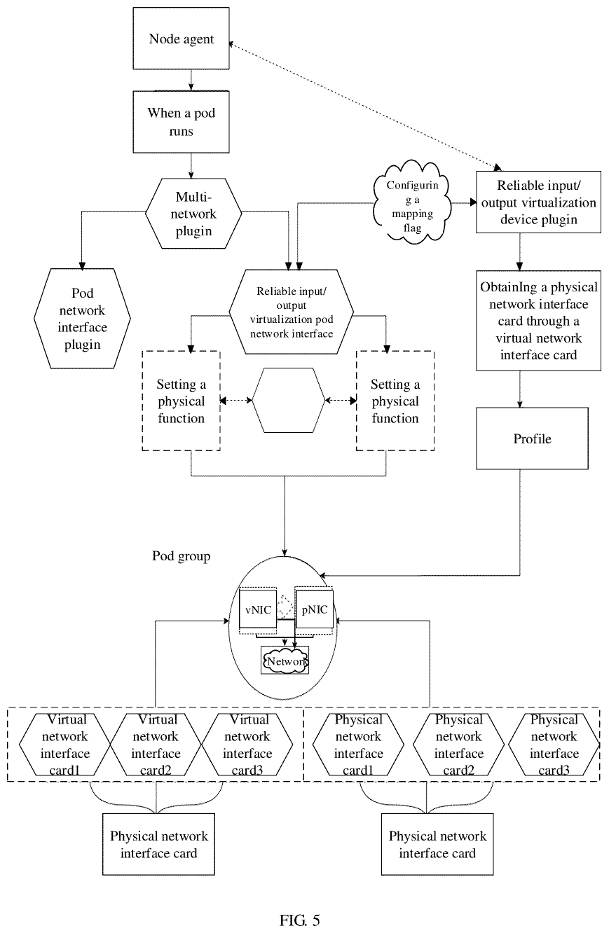

To better introduce the network interface card configuration method provided by the embodiments of the present application, as shown in FIG. 5, an embodiment of the present application provides an overall architecture of the network interface card configuration method. Through a device plugin mechanism, during resource scanning and reporting, whether a reliable input/output virtualized network interface card is virtualized is adaptively determined, whether the network interface card is a virtual network interface card or a physical network interface card is identified, and then an identification result is reported to a node agent.

Through the device plugin mechanism, during allocation of network interface card resources, whether a device plugin is virtualized is adaptively determined, and if an allocated network interface card corresponding to the target network interface card identifier is the physical network interface card, a name of the physical network interface card is written into a profile. If the virtual network interface card is allocated, and when a required acceleration card resource corresponding to a pod group is equal to an available acceleration card resource corresponding to the node agent, the physical network interface card corresponding to the virtual network interface card is obtained, and a network interface card identifier of the physical network interface card is written into the profile. When the required acceleration card resource corresponding to the pod group is less than the available acceleration card resource corresponding to the node agent, the network interface card identifier of the virtual network interface card is written into the configuration file.

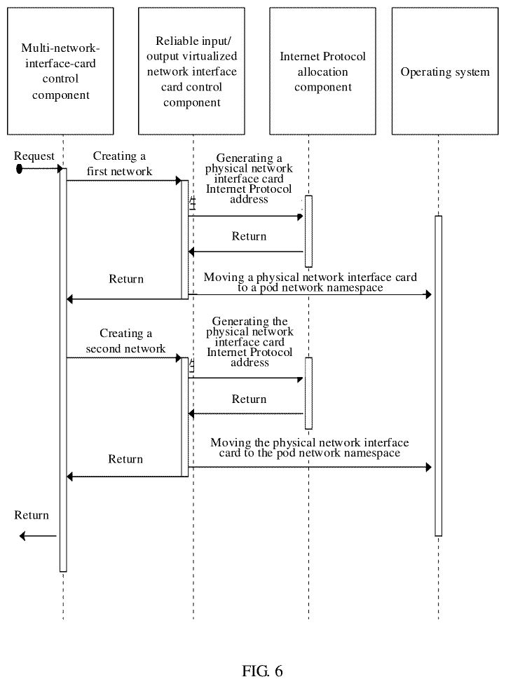

In an optional implementation of the present application, provided is a flowchart of creation of a pod group. As shown in FIG. 6, during creation of the pod group, a multi-network-interface-card control component creates a first network according to a pod group creation request. A reliable input/output virtualized network interface card control component generates a physical network interface Internet Protocol address. An Internet Protocol allocation component returns, and the reliable input/output virtualized network interface card control component moves the physical network interface card to the pod network namespace.

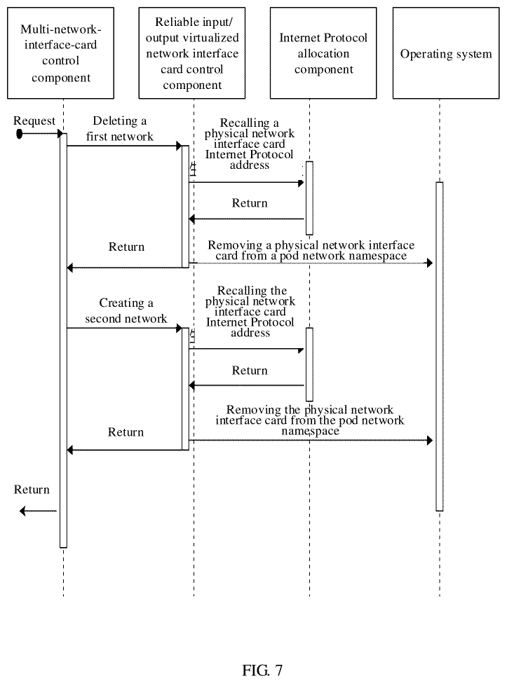

In an optional implementation of the present application, provided is a flowchart of deletion of a pod group. As shown in FIG. 7, when the pod group is deleted, a multi-network-interface-card control component deletes a first network according to a pod group deletion request. A reliable input/output virtualized network interface card control component receives a physical network interface card Internet Protocol address. An Internet Protocol allocation component returns, and the reliable input/output virtualized network interface card control component removes the physical network interface card from the pod network namespace.

The present embodiment further provides a network interface card configuration apparatus. The apparatus is configured to implement the foregoing embodiments and implementations. Those that are already stated are not repeated herein. As used below, a term “module” may be a combination of software and/or hardware that implements a predetermined function. Although the apparatus described in the following embodiments is in some embodiments implemented by software, the apparatus may also be implemented by the hardware, or a combination of software and hardware.

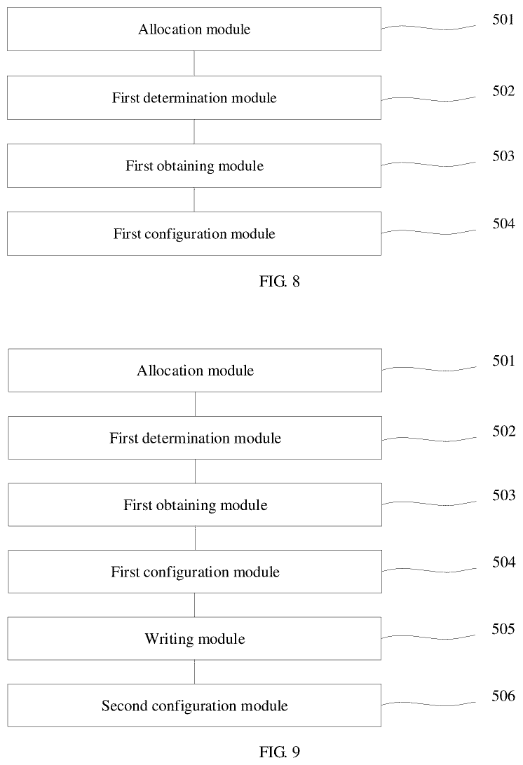

The present embodiment provides a network interface card configuration apparatus, as shown in FIG. 8, which includes:
an allocation module 501, configured to allocate a target network interface card identifier to a target pod group during creation of the target pod group;

a first determination module 502, configured to determine whether a target network interface card corresponding to the target network interface card identifier is a target virtual network interface card or a target physical network interface card, where the target virtual network interface card is obtained by virtualizing the target physical network interface card;
a first obtaining module 503, configured to obtain a first required acceleration card resource corresponding to the target pod group when the target network interface card corresponding to the target network interface card identifier is the target virtual network interface card; and
a first configuration module 504, configured to configure the target virtual network interface card or the target physical network interface card corresponding to the target virtual network interface card for the target pod group according to the first required acceleration card resource, to enable the target pod group to be created successfully.

In an optional implementation, a first determination module 502 is in some embodiments configured to obtain a motherboard external hardware device inventory in a server node corresponding to the target network interface card; find device information corresponding to each motherboard external hardware device according to the motherboard external hardware device inventory; find whether virtualization flag information for virtualization of the target physical network interface card corresponding to the server node exists in the device information; determine that the target network interface card corresponding to the target network interface card identifier is the target virtual network interface card when the virtualization flag information exists; and determine that the target network interface card corresponding to the target network interface card identifier is the target physical network interface card when no virtualization flag information exists.

In some optional implementations, the first configuration module 504 is in some embodiments configured to obtain a first available acceleration card resource corresponding to a server node to which the target pod group is scheduled; compare the first required acceleration card resource with the first available acceleration card resource; and configure the target virtual network interface card or the target physical network interface card corresponding to the target virtual network interface card to the target pod group according to a comparison result.

In some optional implementations, the first configuration module 504 is configured to obtain the target physical network interface card corresponding to the target virtual network interface card when the first required acceleration card resource is equal to the first available acceleration card resource; and configure the target physical network interface card corresponding to the target virtual network interface card for the target pod group.

In some optional implementations, the first configuration module 504 is configured to obtain a target physical network interface card identifier corresponding to the target physical network interface card; write the target physical network interface card identifier into an acceleration profile corresponding to the target pod group; and mount the acceleration profile to the target pod group, and configure the target physical network interface card to the target pod group.

In some optional implementations, the first configuration module 504 is in some embodiments configured to generate a first unique Internet Protocol address corresponding to the target physical network interface card according to first network segment information corresponding to the target physical network interface card; move the target physical network interface card to a pod network namespace corresponding to the target pod group from an initial network namespace; and configure the first unique Internet Protocol address for the target physical network interface card, and activate the target physical network interface card.

In some optional implementations, the first configuration module 504 is configured to write the target network interface card identifier into the acceleration profile corresponding to the target pod group when the first required acceleration card resource is less than the first available acceleration card resource; and mount the acceleration profile to the target pod group, and configure the target virtual network interface card to the target pod group.

In some optional implementations, the first configuration module 504 is configured to query first data link information corresponding to the target virtual network interface card according to the target network interface card identifier information; generate a second unique Internet Protocol address corresponding to the target virtual network interface card according to second network segment information corresponding to the target virtual network interface card; generate a target physical address corresponding to the target virtual network interface card according to the second unique Internet Protocol address, and back up a first original physical address corresponding to the target virtual network interface card; configure the target physical address for the target virtual network interface card according to the first data link information; move the target virtual network interface card to the pod network namespace corresponding to the target pod group from the initial network namespace; and configure the second unique Internet Protocol address for the target virtual network interface card according to the first data link information, and activate the target virtual network interface card.

In some optional implementations, as shown in FIG. 9, the foregoing network interface card configuration apparatus further includes:
a writing module 505, configured to write the target network interface card identifier into the acceleration profile corresponding to the target pod group when the target network interface card corresponding to the target network interface card identifier is the target physical network interface card; and
a second configuration module 506, configured to mount the acceleration profile to the target pod group, and configure the target physical network interface card to the target pod group.

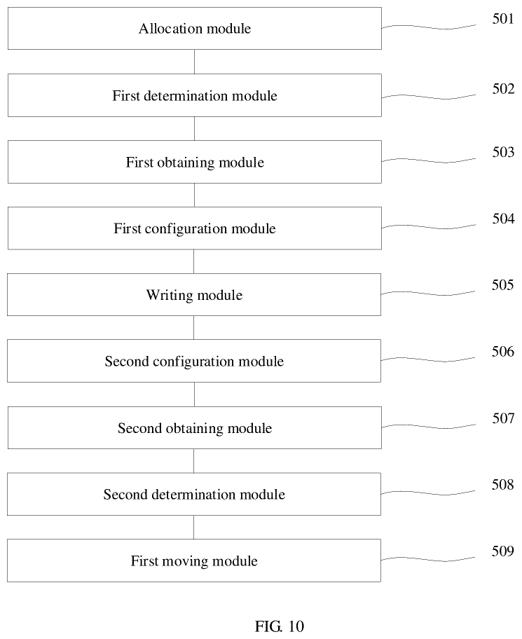

In some optional implementations, as shown in FIG. 10, the foregoing network interface card configuration apparatus further includes:
a second obtaining module 507, configured to obtain a to-be-deleted network interface card identifier corresponding to a to-be-deleted pod group;
a second determination module 508, configured to determine whether a to-be-deleted network interface card corresponding to the to-be-deleted network interface card identifier is a to-be-deleted virtual network interface card or a to-be-deleted physical network interface card; and
a first moving module 509, configured to move the to-be-deleted physical network interface card to the initial network namespace from the pod network namespace corresponding to the to-be-deleted pod group.

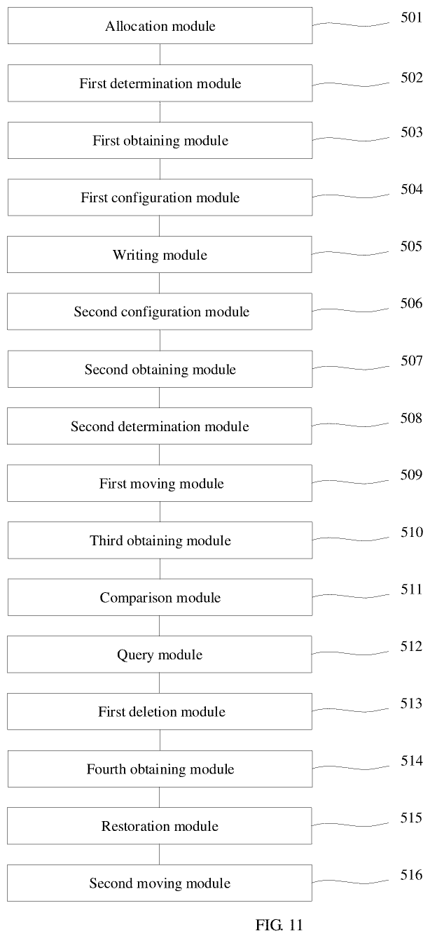

In some optional implementations, as shown in FIG. 11, the foregoing network interface card configuration apparatus further includes:
a third obtaining module 510, configured to obtain a second required acceleration card resource corresponding to the to-be-deleted pod group and a second available acceleration card resource corresponding to a server node to which the to-be-deleted pod group is scheduled when the to-be-deleted network interface card is the to-be-deleted virtual network interface card;
a comparison module 511, configured to compare the second required acceleration card resource with the second available acceleration card resource;
a query module 512, configured to query second data link information corresponding to the to-be-deleted virtual network interface card according to the to-be-deleted network interface card identifier when the second required acceleration card resource is less than the second available acceleration card resource;
a first deletion module 513, configured to obtain a to-be-deleted Internet Protocol address corresponding to the to-be-deleted virtual network interface card, and delete the to-be-deleted Internet Protocol address according to the second data link information;
a fourth obtaining module 514, configured to obtain a second original physical address corresponding to the to-be-deleted virtual network interface card;
a restoration module 515, configured to restore the second original physical address for the to-be-deleted virtual network interface card; and
a second moving module 516, applied to the restoration module, and configured to move to-be-deleted virtual network interface card to the initial network namespace from the pod network namespace corresponding to the to-be-deleted pod group.

In the present embodiment, the network interface card configuration apparatus is presented in a form of functional units, where the units refer to application specific integrated circuits (ASICs), processors and memories that execute one or more software or fixed programs, and/or other devices that might provide the aforementioned functions.

Further functional descriptions of the aforementioned modules and units are the same as those of the aforementioned corresponding embodiments, and are not repeated here.

An embodiment of the present application further provides an electronic device, which is provided with the network interface card configuration apparatus shown in FIG. 8 to FIG. 11.

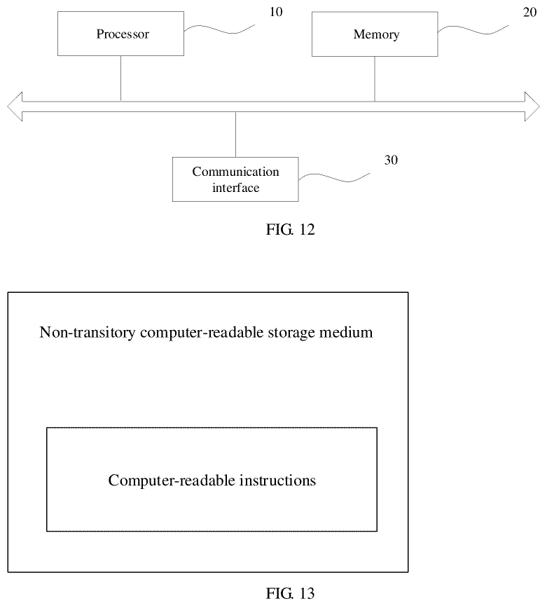

Referring to FIG. 12, FIG. 12 is a schematic structural diagram of an electronic device provided by an optional embodiment of the present application. As shown in FIG. 12, the electronic device includes one or more processors 10, a memory 20, and an interface for connecting all components and including a high-speed interface and a low-speed interface. All components are in communication connection with one another by using different buses, and may be installed onto a public main-board or installed in other manners according to the requirements. The processor may process instructions that are executed in the electronic device, including instructions stored in or on a memory to display graphical information of a graphical user interface (GUI) on an external input/output device (such as a display device coupled to the interface). In some optional implementations, a plurality of processors and/or a plurality of buses may be used together with a plurality of memories when necessary. Similarly, a plurality of electronic devices may be connected. Each device provides necessary operations (such as a server array, a group of blade servers, or a multi-processor system). In FIG. 12, a processor 10 is taken as an example.

The processor 10 may be a central processing unit, a network processor, or a combination thereof. The processor 10 may further include a hardware chip. The hardware chip may be an application specific integrated circuit, a programmable logic device or a combination thereof. The programmable logic device may be a complex programmable logic device, a field programmable logic gate array, a generic array logic or any combination thereof

The memory 20 stores instructions capable of being executed by the at least one processor 10, whereby the at least one processor 10 executes the method in the foregoing embodiments.

The memory 20 may include a program storage area and a data storage area, where the program storage area may store an operating system and an application program required by at least one function; and the data storage area may store data created by the use of the electronic device according to the presentation of a mini program landing page, etc. Furthermore, the memory 20 may include a high-speed random access memory and a non-transitory memory, such as at least one disk storage device, a flash storage device, or other non-transitory solid-state storage devices. In some optional implementations, the memory 20 in some embodiments includes a memory that is arranged remotely relative to the processor 10. These remote memories may be connected to the electronic device through a network. Examples of the network include, but are not limited to the Internet, Intranets, local area networks (LANs), mobile communication networks, and combinations thereof.

The memory 20 may include a volatile memory, such as a random access memory; the memory may also include a non-transitory memory, such as a flash memory, a hard disk or a solid-state hard disk; and the memory 20 may also include a combination of the foregoing memories.

The electronic device further includes a communication interface 30 that is configured for communication between the electronic device and another device or a communication network.

An embodiment of the present application further provides a non-transitory computer-readable storage medium, where the method according to the embodiments of the present application may be implemented in hardware, or firmware, or may be implemented as a computer code that might be recorded in the storage medium, or downloaded through a network and originally stored in a remote storage medium or a non-transitory machine-readable storage medium and may be stored in a local storage medium, whereby the method described herein may be processed by the software that is stored in the storage medium of a general-purpose computer, a dedicated processor, or a programmable or dedicated hardware. The storage medium may be a magnetic disk, an optical disk, a read-only memory, a random access memory, a flash memory, a hard disk or a solid-state hard disk. Further, the storage medium may also include a combination of the above kinds of memories. It should be understood that a computer, a processor, a microprocessor controller or programmable hardware includes a storage component that might store or receive the software or computer code, and when the software or computer code is accessed and executed by the computer, the processor, or the hardware, the method shown in the above embodiment is implemented.

Although the embodiments of the present application are described in combination with the drawings, those skilled in the art might make various modifications and variations without departing from the spirit and scope of the present application, and the modifications and variations shall fall within the scope defined by the appended claims.

1. A network interface card configuration method, comprising:
associating a target pod group with a target network interface card identifier during generation of the target pod group, the target pod group being a pod group for executing deep learning tasks in a current server node;
determining whether a target network interface card corresponding to the target network interface card identifier is a target virtual network interface card or a target physical network interface card, the target virtual network interface card being obtained by virtualizing the target physical network interface card;
in response to the target network interface card corresponding to the target network interface card identifier being the target virtual network interface card, obtaining a first required acceleration card resource corresponding to the target pod group, the first required acceleration card resource being an acceleration card resource that is expected to be used for communication between the target pod group on the current server node and a pod group on another server node when the target pod group executes the deep learning tasks; and
according to the first required acceleration card resource, configuring the target virtual network interface card for the target pod group, or mapping the target virtual network interface card to the target physical network interface card corresponding to the target virtual network interface card and configuring the target physical network interface card corresponding to the target virtual network interface card for the target pod group.

2. The method according to claim 1, wherein the determining whether a target network interface card corresponding to the target network interface card identifier is a target virtual network interface card or a target physical network interface card comprises:
obtaining a motherboard external hardware device inventory in a server node corresponding to the target network interface card;
reading device information corresponding to each motherboard external hardware device according to the motherboard external hardware device inventory;
determining whether virtualization flag information for virtualization of the target physical network interface card corresponding to the server node exists in the device information;
in response to the virtualization flag information existing, determining that the target network interface card corresponding to the target network interface card identifier is the target virtual network interface card; and
in response to no virtualization flag information existing, determining that the target network interface card corresponding to the target network interface card identifier is the target physical network interface card.

3. The method according to claim 1, wherein the according to the first required acceleration card resource, configuring the target virtual network interface card for the target pod group, or mapping the target virtual network interface card to the target physical network interface card corresponding to the target virtual network interface card and configuring the target physical network interface card corresponding to the target virtual network interface card for the target pod group comprises:
obtaining a first available acceleration card resource corresponding to a server node to which the target pod group is scheduled, wherein the first available acceleration card resource is an acceleration card resource that is actually loaded in the current server node in which the target pod group is located;
comparing the first required acceleration card resource with the first available acceleration card resource; and
according to a comparison result, configuring the target virtual network interface card for the target pod group, or mapping the target virtual network interface card to the target physical network interface card corresponding to the target virtual network interface card and configuring the target physical network interface card corresponding to the target virtual network interface card for the target pod group.

4. The method according to claim 3, wherein the according to a comparison result, configuring the target virtual network interface card for the target pod group, or mapping the target virtual network interface card to the target physical network interface card corresponding to the target virtual network interface card and configuring the target physical network interface card corresponding to the target virtual network interface card for the target pod group comprises:
in response to the first required acceleration card resource being equal to the first available acceleration card resource, obtaining the target physical network interface card corresponding to the target virtual network interface card; and
mapping the target virtual network interface card to the target physical network interface card corresponding to the target virtual network interface card, and configuring the target physical network interface card corresponding to the target virtual network interface card for the target pod group.

5. The method according to claim 4, wherein the configuring the target physical network interface card corresponding to the target virtual network interface card for the target pod group comprises:
obtaining a target physical network interface card identifier corresponding to the target physical network interface card;
writing the target physical network interface card identifier into an acceleration profile corresponding to the target pod group; and
mounting the acceleration profile to the target pod group, and configuring the target physical network interface card to the target pod group.

6. The method according to claim 5, wherein the configuring the target physical network interface card to the target pod group comprises:
according to first network segment information corresponding to the target physical network interface card, generating a first unique Internet Protocol address corresponding to the target physical network interface card;
moving the target physical network interface card to a pod network namespace corresponding to the target pod group from an initial network namespace; and
configuring the first unique Internet Protocol address for the target physical network interface card, and activating the target physical network interface card.

7. The method according to claim 4, wherein the according to a comparison result, configuring the target virtual network interface card for the target pod group, or mapping the target virtual network interface card to the target physical network interface card corresponding to the target virtual network interface card and configuring the target physical network interface card corresponding to the target virtual network interface card for the target pod group further comprises:
in response to the first required acceleration card resource being less than the first available acceleration card resource, writing the target network interface card identifier into an acceleration profile corresponding to the target pod group; and
mounting the acceleration profile to the target pod group, and configuring the target virtual network interface card to the target pod group.

8. The method according to claim 7, wherein the configuring the target virtual network interface card to the target pod group comprises:
querying first data link information corresponding to the target virtual network interface card according to target network interface card identifier information;
generating a second unique Internet Protocol address corresponding to the target virtual network interface card according to second network segment information corresponding to the target virtual network interface card;
generating a target physical address corresponding to the target virtual network interface card according to the second unique Internet Protocol address, and backing up a first original physical address corresponding to the target virtual network interface card;
configuring the target physical address for the target virtual network interface card according to the first data link information;
moving the target virtual network interface card to a pod network namespace corresponding to the target pod group from an initial network namespace; and
configuring the second unique Internet Protocol address for the target virtual network interface card according to the first data link information, and activating the target virtual network interface card.

9. The method according to claim 1, further comprising:
in response to the target network interface card corresponding to the target network interface card identifier being the target physical network interface card, writing the target network interface card identifier into an acceleration profile corresponding to the target pod group; and
mounting the acceleration profile to the target pod group, and configuring the target physical network interface card to the target pod group.

10. The method according to claim 1, further comprising:
obtaining a to-be-deleted network interface card identifier corresponding to a to-be-deleted pod group;
determining whether a to-be-deleted network interface card corresponding to the to-be-deleted network interface card identifier is a to-be-deleted virtual network interface card or a to-be-deleted physical network interface card; and
in response to the to-be-deleted network interface card being is the to-be-deleted physical network interface card, moving the to-be-deleted physical network interface card to an initial network namespace from a pod network namespace corresponding to the to-be-deleted pod group.

11. The method according to claim 10, further comprising:
in response to the to-be-deleted network interface card being the to-be-deleted virtual network interface card, obtaining a second required acceleration card resource corresponding to the to-be-deleted pod group and a second available acceleration card resource corresponding to a server node to which the to-be-deleted pod group is scheduled;
comparing the second required acceleration card resource with the second available acceleration card resource;
in response to the second required acceleration card resource being is less than the second available acceleration card resource, querying second data link information corresponding to the to-be-deleted virtual network interface card according to the to-be-deleted network interface card identifier;
obtaining a to-be-deleted Internet Protocol address corresponding to the to-be-deleted virtual network interface card, and deleting the to-be-deleted Internet Protocol address according to the second data link information;
obtaining a second original physical address corresponding to the to-be-deleted virtual network interface card;
restoring the second original physical address for the to-be-deleted virtual network interface card; and
moving the to-be-deleted virtual network interface card to the initial network namespace from the pod network namespace corresponding to the to-be-deleted pod group.

12. The method according to claim 11, further comprising:
in response to the second required acceleration card resource being equal to the second available acceleration card resource, finding the to-be-deleted physical network interface card corresponding to the to-be-deleted virtual network interface card according to the to-be-deleted network interface card identifier; and
deleting a to-be-deleted Internet Protocol address corresponding to the to-be-deleted physical network interface card, and moving the to-be-deleted physical network interface card to the initial network namespace from the pod network namespace corresponding to the to-be-deleted pod group.

13. The method according to claim 12, further comprising:
in response to the second required acceleration card resource being greater than the second available acceleration card resource, finding the to-be-deleted physical network interface card corresponding to the to-be-deleted virtual network interface card according to the to-be-deleted network interface card identifier; and
deleting the to-be-deleted Internet Protocol address corresponding to the to-be-deleted physical network interface card, and moving the to-be-deleted physical network interface card to the initial network namespace from the pod network namespace corresponding to the to-be-deleted pod group.

14. The method according to claim 11, wherein the second required acceleration card resource is an acceleration card resource that is expected to be used for communication between the to-be-deleted pod group on the current server node and the pod group on the another server node when the to-be-deleted pod group executes the deep learning tasks.

15. The method according to claim 11, wherein the second available acceleration card resource is an acceleration card resource that is actually loaded in the current server node in which the to-be-deleted pod group is located.

16. The method according to claim 1, wherein communication between pod groups on a plurality of server nodes comprises communication between graphics processing units (GPUs) corresponding to the pod groups on the plurality of server nodes.

17. The method according to claim 1, wherein the according to the first required acceleration card resource, configuring the target virtual network interface card for the target pod group, or mapping the target virtual network interface card to the target physical network interface card corresponding to the target virtual network interface card and configuring the target physical network interface card corresponding to the target virtual network interface card for the target pod group comprises:
determining a communication performance requirement of the target pod group corresponding to the deep learning tasks according to the first required acceleration card resource;
in response to the communication performance requirement being less than a preset threshold, configuring the target virtual network interface card for the target pod group; and
in response to the communication performance requirement being greater than or equal to the preset threshold, mapping the target virtual network interface card to the target physical network interface card corresponding to the target virtual network interface card, and configuring the target physical network interface card corresponding to the target virtual network interface card for the target pod group.

18. (canceled)

19. An electronic device, comprising:
a memory and a processor, the memory and the processor being in communication connection with each other, the memory having computer instructions stored therein, the processor executing the computer instructions to execute a network interface card configuration method, comprising:
associating a target pod group with a target network interface card identifier during generation of the target pod group, the target pod group being a pod group for executing deep learning tasks in a current server node;
determining whether a target network interface card corresponding to the target network interface card identifier is a target virtual network interface card or a target physical network interface card, the target virtual network interface card being obtained by virtualizing the target physical network interface card;
in response to the target network interface card corresponding to the target network interface card identifier being the target virtual network interface card, obtaining a first required acceleration card resource corresponding to the target pod group, the first required acceleration card resource being an acceleration card resource that is expected to be used for communication between the target pod group on the current server node and a pod group on another server node when the target pod group executes the deep learning tasks; and
according to the first required acceleration card resource, configuring the target virtual network interface card for the target pod group, or mapping the target virtual network interface card to the target physical network interface card corresponding to the target virtual network interface card and configuring the target physical network interface card corresponding to the target virtual network interface card for the target pod group.

20. A non-transitory computer-readable storage medium, having computer instructions stored therein, the computer instructions being configured for enabling a computer for:
associating a target pod group with a target network interface card identifier during generation of the target pod group, the target pod group being a pod group for executing deep learning tasks in a current server node;
determining whether a target network interface card corresponding to the target network interface card identifier is a target virtual network interface card or a target physical network interface card, the target virtual network interface card being obtained by virtualizing the target physical network interface card;
in response to the target network interface card corresponding to the target network interface card identifier being the target virtual network interface card, obtaining a first required acceleration card resource corresponding to the target pod group, the first required acceleration card resource being an acceleration card resource that is expected to be used for communication between the target pod group on the current server node and a pod group on another server node when the target pod group executes the deep learning tasks; and
according to the first required acceleration card resource, configuring the target virtual network interface card for the target pod group, or mapping the target virtual network interface card to the target physical network interface card corresponding to the target virtual network interface card and configuring the target physical network interface card corresponding to the target virtual network interface card for the target pod group.

21. The method according to claim 1, wherein the determining whether a target network interface card corresponding to the target network interface card identifier is a target virtual network interface card or a target physical network interface card comprises:
adaptively identifying, via a device plugin mechanism, whether the target network interface card is virtualized during resource scanning and reporting; and
reporting an identification result to a node agent.
